(19) United States
(12) Patent Application Publication
(10) Pub. No.: US 2018/0281176 A1
(43) Pub. Date: Oct. 4, 2018

(54) POSITION ESTIMATION METHOD AND HOLDING METHOD

(71) Applicant: HONDA MOTOR CO., LTD., Tokyo (JP)

(72) Inventors: Yasutaka Ishizuka, Tochigi (JP); Yuya Kaichi, Tochigi (JP); Kotaro Muraoka, Tochigi (JP)

(21) Appl. No.: 15/941,098

(22) Filed: Mar. 30, 2018

(30) Foreign Application Priority Data
Mar. 30, 2017 (JP) 2017-067242

(51) Int. Cl. B25J 9/10; B25J 15/00

(52) U.S. Cl. CPC B25J 9/1015; B25J 11/005; Y10S 901/39; B25J 15/0042

(57) ABSTRACT

A position estimation method capable of quickly estimating a position of an end of a cylindrical object. A holding-robot controller includes a correction control amount computation part configured to output a correction control amount of a position and a posture of a holding tool so as to reduce the chuck width. The position estimation method includes: a step of causing a pair of clamping claws to approach each other in a reference position and a reference posture to temporarily hold an engine damper; a step of correcting the position and the posture of the holding tool using a correction control amount; a step of causing the pair of clamping claws to approach each other in the position and the posture after the position/posture correction step to temporarily re-hold the engine damper; and an end position estimation step of estimating end position coordinates of the engine damper.

This application is based on and claims the benefit of priority from Japanese Patent Application No. 2017-067242, filed on 30 Mar. 2017, the content of which is incorporated herein by reference.

### BACKGROUND OF THE INVENTION

### Field of the Invention

The present invention relates to a position estimation method and a holding method. More specifically, the present invention relates to a position estimation method in which a holding system configured to hold a cylindrical object is used to estimate end position coordinates of one end of the cylindrical object, and a holding method of a cylindrical object to hold the cylindrical object in such a manner that the end position coordinates of the cylindrical object can be estimated.

### Related Art

A vehicle engine is mounted on a vehicle body via a framework called an engine mount. To suppress vibrations of the engine, an engine damper having a cylindrical shape is mounted between the engine and the engine mount. The engine damper is mounted in such a manner that a base end thereof is engaged with the engine mount and a tip end thereof is fastened to the engine with a bolt, for example.

In a manufacturing process of vehicles, mounting of engine dampers on engines is performed by a damper holding robot configured to hold an engine damper and position the engine damper at a predetermined position on the engine, and a fastening robot configured to fasten the engine damper that has been positioned by the damper holding robot with a bolt. Since positioning of the engine dampers by the damper holding robot includes errors, the position of the tip end of the engine damper is slightly different in each operation performed by the damper holding robot. Accordingly, the fastening robot needs to precisely identify the position and the posture of a bolt hole provided at the tip end of the positioned engine damper at the time of fastening the bolt.

For example, JP 10-326347 A discloses a technique to detect the three-dimensional position and posture of an object by image processing. Since a hole has a circle shape as viewed from the front, the technique disclosed in JP 10-326347 A extracts a point sequence that appears to form a circle from image data of an object acquired using a camera so that the three-dimensional position and posture of the object is detected based on the position data of the point sequence. In view of the above, the mounting process of the engine damper on the engine may employ the technique disclosed in JP 10-326347 A to identify the position and the posture of the bolt hole at the tip end of the engine damper so that the fastening robot fastens the bolt in an appropriate manner according to the position and the posture thus identified.

### SUMMARY OF THE INVENTION

However, such a method using the technique disclosed in JP 10-326347 A additionally requires a camera to capture an image of the tip end of the damper and also requires a robot or the like to move the camera, which may cause an increase in costs corresponding to such additional equipment. In addition, the method requires the capturing of an image by using camera every time the fastening step is performed and also requires processing of the acquired image data, which may also cause an increase in cycle time corresponding to such additional steps.

An object of the present invention is to provide a position estimation method capable of quickly estimating a position of an end of a cylindrical object while utilizing existing facilities, and a holding method capable of holding the cylindrical object in a condition in which the position of one end thereof can be estimated.

(1) A position estimation method according to the present invention estimates end position coordinates of one end of a cylindrical object using a holding system configured to hold the cylindrical object. The holding system includes: a holding apparatus equipped with a pair of clamping claws configured to hold the cylindrical object such that a holding center axis is coaxial with a center axis of the cylindrical object when the clamping claws are in the closest approach to each other, and equipped with a holding width detection device configured to output a width detection value according to a holding width of the clamping claws; and a control device configured to control a position and a posture of the holding apparatus, and the control device includes a correction device configured to output a correction control amount of the position and the posture of the holding apparatus so as to reduce the holding width when the width detection value is input. The position estimation method includes: an initial temporary holding step of causing the pair of clamping claws to approach each other in a reference position and a reference posture and temporarily holding the cylindrical object; a correction step of correcting the position and the posture of the holding apparatus with the correction control amount obtained by inputting the width detection value at a time of the temporary holding of the cylindrical object into the correction device; a temporary re-holding step of causing the pair of clamping claws to approach each other in the position and the posture after the correction step and temporarily re-holding the cylindrical object; and an estimation step of estimating the end position coordinates using a deviation from the reference position and the reference posture of the position and the posture of the holding apparatus when the width detection value becomes equal to or less than a threshold value after the correction step and the temporary re-holding step are repeated.

(2) In this configuration, it is preferable that the correction device has input-output characteristics from the width detection value to the correction control amount constructed by reinforcement learning.

(3) In this configuration, it is preferable that the control device includes: a robot having an arm of which tip end is equipped with the holding apparatus; and a robot controller configured to drive the robot to control the position and the posture of the holding apparatus, the holding apparatus includes: an actuator; a power transmission mechanism that causes the pair of clamping claws to approach or move away from each other using power generated by the actuator; and a force sensor with six axes provided between the power transmission mechanism and the tip end of the arm, and the correction device is configured to use the width detection value and a value detected by the force sensor and compute the correction control amount so as to reduce the holding width.

(4) A holding method according to the present invention is a method of holding a cylindrical object using a holding system. The holding system includes: a holding apparatus equipped with a pair of clamping claws configured to hold the cylindrical object such that a holding center axis is coaxial with a center axis of the cylindrical object when the clamping claws are in the closest approach to each other, and equipped with a holding width detection device configured to output a width detection value according to a holding width of the clamping claws; and a control device configured to control a position and a posture of the holding apparatus, and the control device includes a correction device configured to output a correction control amount of the position and the posture of the holding apparatus so as to reduce the holding width when the width detection value is input. The holding method includes: an initial temporary holding step of causing the pair of clamping claws to approach each other in a reference position and a reference posture and temporarily holding the cylindrical object; a correction step of correcting the position and the posture of the holding apparatus with the correction control amount obtained by inputting the width detection value at a time of the temporary holding of the cylindrical object in the correction device; and a temporary re-holding step of causing the pair of clamping claws to approach each other in the position and the posture after the correction step and temporarily re-holding the cylindrical object, and the holding apparatus holds the cylindrical object by repeating the correction step and the temporary re-holding step until the width detection value becomes equal to or less than the threshold value.

(1) The position estimation method according to the present invention estimates end position coordinates of a cylindrical object by using: a holding apparatus equipped with a pair of clamping claws configured to hold the cylindrical object in such a manner that a holding center axis is coaxial with a center axis of the cylindrical object when the clamping claws are at the closest approach to each other, and equipped with a holding width detection device configured to detect a holding width of the clamping claws; and a correction device configured to output a correction control amount of a position and a posture of the holding apparatus so as to reduce the holding width of the clamping claws when receiving the width detection value.

This position estimation method includes: an initial holding step; a correction step; a temporary re-holding step; and an estimation step of estimating the end position coordinates after repeating the correction step and the temporary re-holding step. In the initial holding step, the clamping claws are caused to approach each other in a reference position and a reference posture, and temporarily hold the cylindrical object. The pair of clamping claws is configured such that the holding center axis thereof is coaxial with the center axis of the cylindrical object when the clamping claws are at the closest approach to each other. Accordingly, in the case where the holding center axis of the holding apparatus in the reference position and the reference posture is not coaxial with the center axis of the cylindrical object, the clamping claws touch a side surface of the cylindrical object before reaching the closest approach to each other at the time of temporary holding of the cylindrical object. At the time of such temporary holding, the holding width of the clamping claws changes according to a deviation condition of the holding center axis of the clamping claws from the center axis of the cylindrical object. In the correction step, the position and the posture of the holding apparatus are corrected using the correction control amount obtained by inputting the width detection value at the time of the temporary holding into the correction device. The correction device is configured to output a correction control amount to reduce the holding width of the clamping claws according to the width detection value. Accordingly, correction of the position and the posture of the holding apparatus can be made using the correction device such that the holding center axis approaches the center axis of the cylindrical object. In the estimation step, the correction step and the temporary re-holding step are repeated until the width detection value becomes equal to or less than the threshold value. As described above, the position and the posture of the holding apparatus are corrected at each temporary holding, which allows the position and the posture of the holding apparatus to approach the position and the posture in which the holding center axis is coaxial with the center axis of the cylindrical object. In the estimation step, the end position coordinates of the cylindrical object are estimated using a deviation from the known reference position and the known reference posture of the position and the posture of the holding apparatus when the width detection value becomes equal to or less than the threshold value after the correction step and the temporary re-holding step are repeated, i.e., the position and the posture of the holding apparatus when the cylindrical object is temporarily held by the clamping claws in a substantially coaxial manner. According to the present invention, the holding system to hold a cylindrical object is utilized for estimating the end position coordinates, which eliminates the need for additionally providing a camera or a robot, and thus the end position of the cylindrical object can be estimated while utilizing the existing facilities. In the case where the cylindrical object is an engine damper, the end position coordinates of the engine damper can be estimated just after the engine damper is positioned using the holding system by applying the position estimation method of the present invention, which achieves quick estimation of the end position coordinates.

(2) In the position estimation method according to the present invention, the correction device has input-output characteristics from the width detection value to the correction control amount constructed by reinforcement learning. The deviation of the holding center axis of the holding apparatus from the center axis of the cylindrical object includes a combination of various modes of deviation, such as translational deviations and tilting deviations. Accordingly, the width detection values do not necessarily have a one to one correspondence with the modes of deviation, and thus the width detection value does not always lead to a unique optimum correction control amount. The position estimation method of the present invention uses the correction device having input-output characteristics constructed by reinforcement learning, and thus the position and the posture of the holding apparatus in which the width detection value is equal to or less than the threshold value can be reliably achieved in the end with a plurality of trials.

(3) According to the position estimation method of the present invention, the holding apparatus includes a power transmission mechanism that causes the clamping claws to approach or move away from each other using the power generated by an actuator, and a force sensor with six axes provided between the power transmission mechanism and the tip end of the arm of the robot. The correction device is configured to compute a correction control amount with the width detection value and six values detected by the force sensor as inputs so as to reduce the holding width. Using the six values detected by the force sensor in addition to the width detection value enables quick identification of the deviation condition of the holding center axis of the holding apparatus from the center axis of the cylindrical object, and thus the position and the posture of the holding apparatus in which the width detection value is equal to or less than the threshold value can be quickly achieved and also the end position coordinates can be quickly estimated.

(4) According to the holding method according to the present invention, a cylindrical object is held using: a holding apparatus equipped with a pair of clamping claws configured to hold the cylindrical object in such a manner that a holding center axis is coaxial with a center axis of the cylindrical object when the clamping claws are at the closest approach to each other, and equipped with a holding width detection device configured to detect a holding width of the clamping claws; and a correction device configured to output a correction control amount of a position and a posture of the holding apparatus so as to reduce the holding width of the clamping claws when receiving the width detection value.

The holding method includes an initial holding step, a correction step, and a temporary re-holding step, and the cylindrical object is held by the holding apparatus by repeating the correction step and the temporary re-holding step until the width detection value becomes equal to or less than the threshold value. According to the present invention, the correction step and the temporary re-holding step are repeated until the width detection value becomes equal to or less than the threshold value, the cylindrical object can be held by the holding apparatus in a position and a posture in which the holding center axis is coaxial with the center axis of the cylindrical object, in other words, in a condition in which the end position coordinates can be estimated with known information such as the length of the cylindrical object, on the same grounds as the above described invention (1). According to the present invention, the cylindrical object is held in a unique state that enables estimation of the end position coordinates, which eliminates the need for additionally providing a camera or a robot to estimate the end position coordinates, and thus the end position of the cylindrical object can be estimated while utilizing the existing facilities.

### BRIEF DESCRIPTION OF THE DRAWINGS

FIG. 1 illustrates a configuration of an engine-damper mounting system according to a first embodiment of the present invention.

FIG. 2 is a broken perspective view illustrating a configuration of a holding tool.

FIG. 3A is a plan view of two clamping claws.

FIG. 3B shows a state in which the two clamping claws are at the closest approach to each other to hold an engine damper.

FIG. 4A schematically shows a T-axis translational deviation.

FIG. 4B schematically shows a B-axis translational deviation.

FIG. 4C schematically shows a B-axis tilting deviation.

FIG. 4D schematically shows a T-axis tilting deviation.

FIG. 5A shows a relationship between a magnitude of a B-T mixed translational deviation and a chuck width.

FIG. 5B shows a relationship between a magnitude of a B-T mixed tilting deviation and the chuck width.

FIG. 6 is a block diagram schematically showing a configuration of a holding-robot controller.

FIG. 7 is a flowchart illustrating specific steps of a position estimation method.

FIG. 8 is a perspective view of a configuration of a holding tool according to a second embodiment of the present invention.

FIG. 9A schematically shows the T-axis translational deviation.

FIG. 9B schematically shows the B-axis translational deviation.

FIG. 9C schematically shows the B-axis tilting deviation.

FIG. 10 shows a configuration of a pin insertion system according to a third embodiment of the present invention.

FIG. 11 is a block diagram schematically showing a configuration of a pin holding-robot controller.

FIG. 12 is a flowchart illustrating specific steps of a holding method.

### DETAILED DESCRIPTION OF THE INVENTION

### First Embodiment

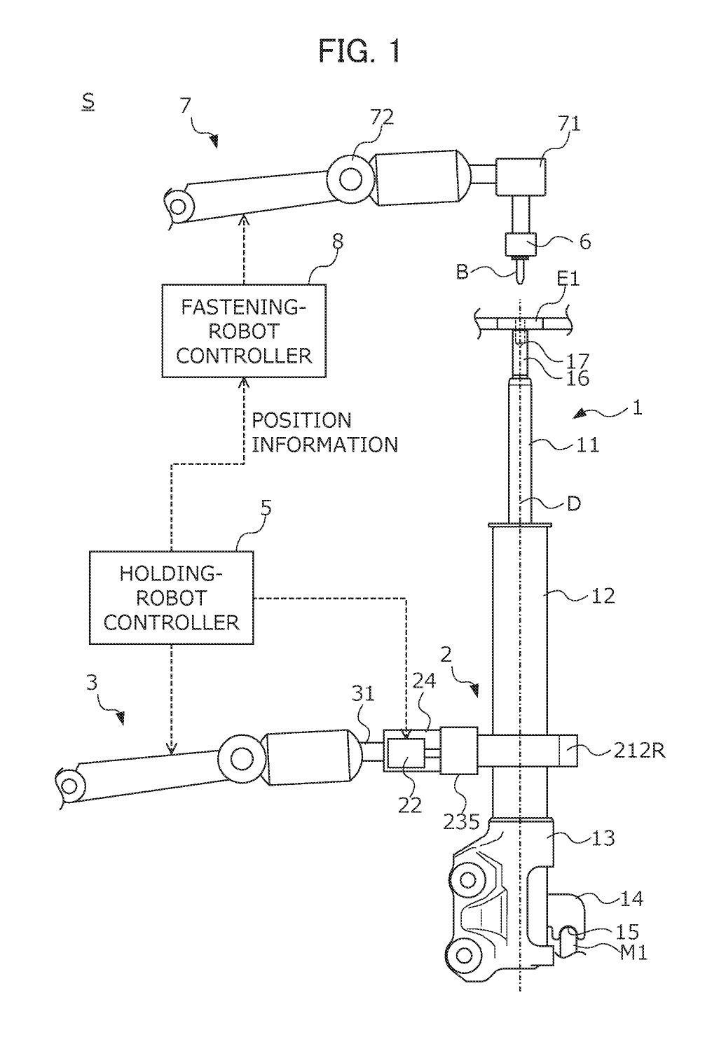

A first embodiment of the present invention is described below with reference to the drawings. FIG. 1 illustrates a configuration of an engine-damper mounting system S to which a position estimation method and a holding method according to the present embodiment is applied.

The engine-damper mounting system S is configured to mount an engine damper 1 for suppressing vibrations of the engine between a vehicle engine and an engine mount that supports the engine. The engine-damper mounting system S includes: a holding tool 2 configured to hold the engine damper 1; a damper holding robot 3 having an arm equipped with the holding tool 2 at a tip end 31 thereof; a holding-robot controller 5 configured to control the holding tool 2 and the damper holding robot 3; a nutrunner 6 configured to fasten a tip end 16 of the engine damper 1 to the engine with a bolt B; a fastening robot 7 having an arm equipped with the nutrunner 6 at a tip end 71 thereof; and a fastening-robot controller 8 configured to control the nutrunner 6 and the fastening robot 7.

The engine damper 1 has a cylindrical shape as a whole, and includes a piston rod 11 having a cylindrical shape extending along a damper axis D; and an outer casing 12 having a cylindrical shape that houses a piston valve (not shown) provided at a base end of the piston rod 11 in a slidable manner along the damper axis D. The outer casing 12 includes at a base end 13 thereof an engaging part 14 having a recess 15 that is opened downward in FIG. 1. The tip end 16 of the piston rod 11 includes a threaded hole 17 that is coaxial with the piston rod 11.

Referring to FIG. 1, the engine damper 1 is provided between the engine and the engine mount such that the bolt B is inserted and fastened to a damper mounting part E1, which is mounted on the engine, and the threaded hole 17 in a state in which the recess 15 at the base end 13 is engaged with a projection M1 provided on the engine mount while the tip end 16 is positioned at the damper mounting part E1 (hereinafter, this state is also referred to as “a temporary fastening state”).

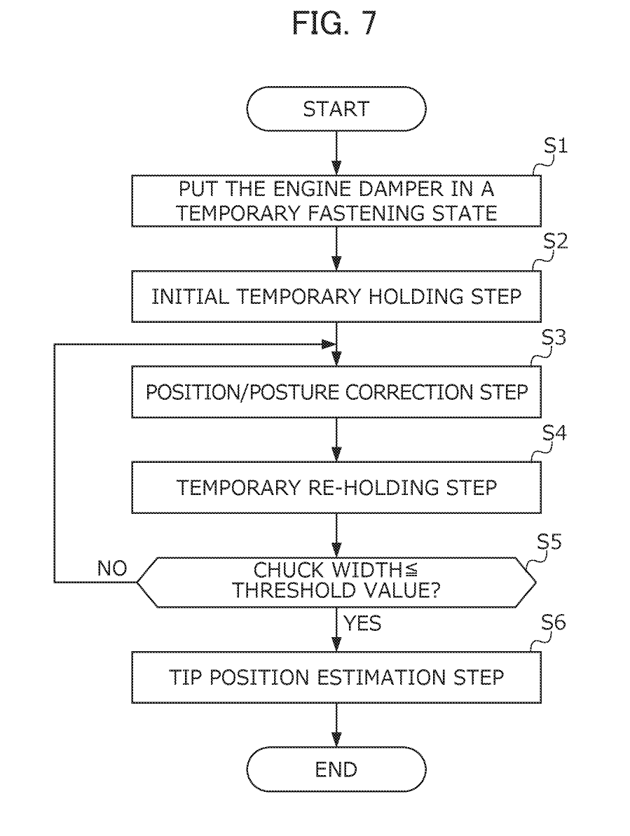

The nutrunner 6 is fixed to the tip end 71 of a multi-articulated arm 72 of the fastening robot 7. After the engine damper 1 is temporarily fastened by the damper holding robot 3, the fastening-robot controller 8 fastens the bolt B to the damper mounting part E1 and the threaded hole 17 while adjusting the position and the posture of the nutrunner 6 using position information of the threaded hole 17 of the engine damper 1 that is estimated by the holding-robot controller 5 using a position estimation method, which is described below with reference to FIG. 7.

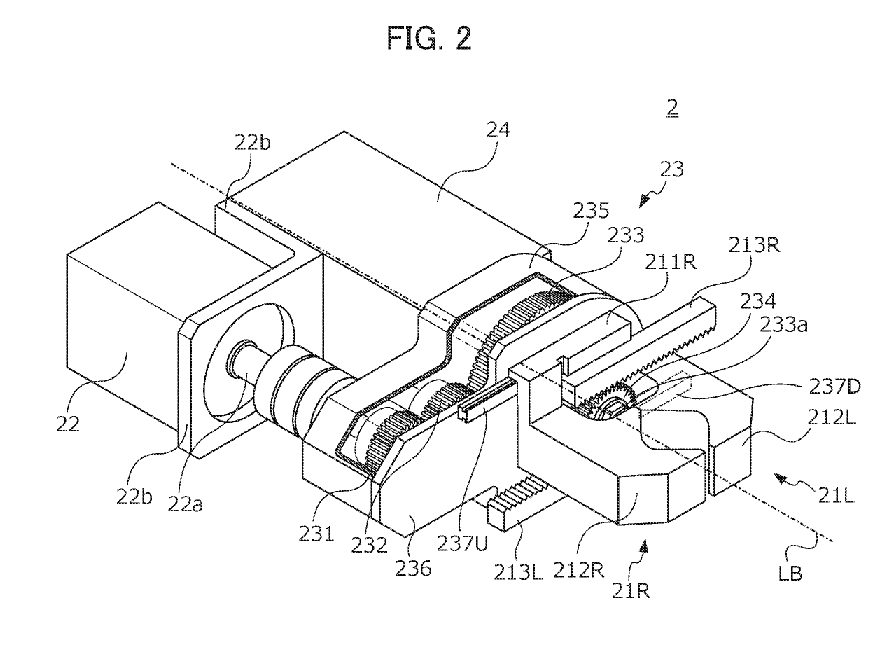

FIG. 2 is a broken perspective view illustrating a configuration of a holding tool 2. The holding tool 2 includes: a pair of clamping plates 21L, 21R, a servomotor 22 configured to rotate a rotary shaft 22a thereof; a power transmission mechanism 23 that causes the two clamping plates 21L, 21R to approach or move away from each other using the power generated by the servomotor 22; and a connection member 24 that connects the power transmission mechanism 23 with the tip end of the arm.

The servomotor 22 rotates the rotary shaft 22a in a forward or reverse direction according to a pulse signal transmitted from the holding-robot controller 5. The servomotor 22 is equipped with an encoder (not shown). The encoder is configured to generate a motor pulse signal corresponding to an angle of the rotary shaft 22a and transmit the motor pulse signal to the holding-robot controller 5. The servomotor 22 is connected to a side surface of the connection member 24 through a stay 22b having a substantially L-shape.

The power transmission mechanism 23 includes: a first pinion gear 231 coaxially connected with the rotary shaft 22a of the servomotor 22; a second pinion gear 232 meshed with the first pinion gear 231; a third pinion gear 233 meshed with the second pinion gear 232; and a gear box 235 that houses the pinion gears 231 to 233 in a rotatable manner. In FIG. 2, a part of the gear box 235 is cut out. In the gear box 235, the third pinion gear 233 is supported by a rotary shaft 233a in a rotatable manner around an axis LB, and a tip end of the rotary shaft 233a projects from a front cover 236 of the gear box 235 that extends in a direction perpendicular to the rotary shaft 233a. A fourth pinion gear 234 is provided coaxially with the third pinion gear 233 at the tip end of the rotary shaft 233a outside the front cover 236.

An upper slide rail 237U and a lower slide rail 237D each having a rod shape are provided in parallel to each other on the front cover 236 on the upper side and the lower side of the axis LB in FIG. 2 respectively. Note that the direction in which each of the slide rails 237U, 237D extends is referred to as a chucking direction.

A rear surface of the gear box 235 opposite to the front cover 236 is connected to an end surface of the box-shaped connection member 24 in a coaxial manner with the axis LB. The connection member 24 has a base surface that is connected to the tip end of the arm of the damper holding robot in a coaxial manner with the axis LB. In other words, the axis of the tip end of the arm is coaxial with the axis LB of the power transmission mechanism 23.

The clamping plate 21R has a base end 211R that extends in parallel to the front cover 236, and a plate-shaped clamping claw 212R that extends from the base end 211R in a direction substantially perpendicular to the front cover 236. The base end 211R includes a groove engaged with the upper slide rail 237U and a rod-shaped upper rack gear 213R that extends in parallel to the upper slide rail 237U. As shown in FIG. 2, the upper rack gear 213R is meshed with the fourth pinion gear 234.

In the same manner as with the clamping plate 21R, the clamping plate 21L has a base end (not shown) that extends in parallel to the front cover 236, and a plate-shaped clamping claw 212L that extends from the base end in a direction substantially perpendicular to the front cover 236. The base end of the clamping plate 21L includes a groove engaged with the lower slide rail 237D and a rod-shaped lower rack gear 213L that extends in parallel to the lower slide rail 237D. As shown in FIG. 2, the lower rack gear 213L is disposed in parallel to the upper rack gear 213R with the fourth pinion gear 234 being interposed between them. The lower rack gear 213L is meshed with the fourth pinion gear 234.

These clamping plates 21L, 21R are arranged in such a manner that the base ends thereof are respectively engaged with the slide rails 237D, 237U, and the rack gears 213L, 213R are meshed with the fourth pinion gear 234, so that the clamping claws 212L, 212R are opposed to each other in the chucking direction across the axis LB and are flush with each other in the thickness direction.

According to the above-described holding tool 2, as the rotary shaft 22a is rotated in a reverse direction by the servomotor 22 from the state illustrated in FIG. 2, the fourth pinion gear 234 rotates in a reverse direction corresponding to the rotation angle of the rotary shaft 22a, so that the clamping claws 212L, 212R move away from each other in the chucking direction. As the rotary shaft 22a is rotated in a forward direction by the servomotor 22, the fourth pinion gear 234 rotates in a forward direction corresponding to the rotation angle of the rotary shaft 22a, so that the clamping claws 212L, 212R approach each other in the chucking direction.

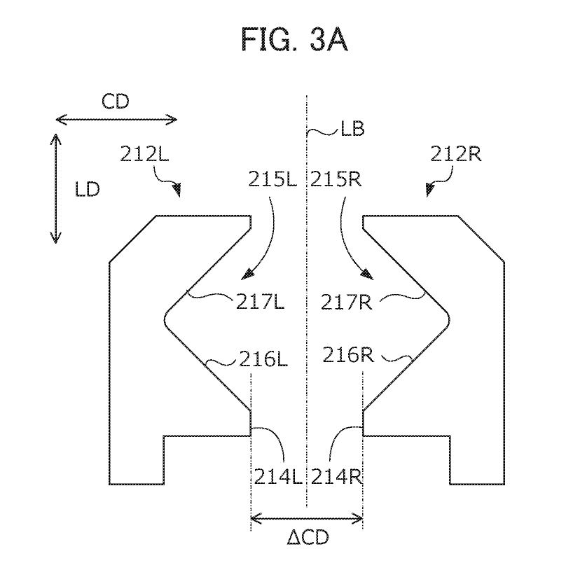

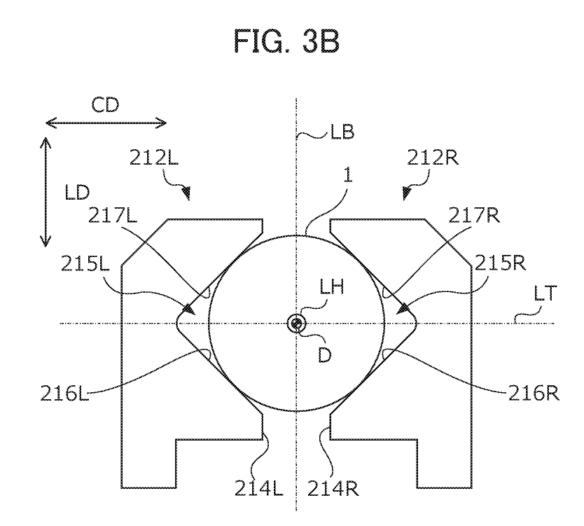

FIG. 3A is a plan view of the clamping claws 212L, 212R as viewed from the thickness direction. As shown in FIG. 3A, each of the clamping claws 212L, 212R has a plate shape extending toward the tip side thereof in a longitudinal direction LD that is perpendicular to a chucking direction CD in plan view. The clamping claws 212L, 212R respectively have inner ends 214L, 214R that face the axis LB of the holding tool and respectively include a left recess 215L and a right recess 215R, each of which has a V-shape and faces the axis LB in plan view.

The left recess 215L includes a left first end 216L and a left second end 217L sequentially from the base side toward the tip side. Each of the ends 216L, 217L includes an end surface tilted at a predetermined angle (at an angle of 45° in the present embodiment) with respect to the axis LB. Note that the predetermined angle of the left recess 215L is not limited to an angle of 45° and may be any angle less than an angle of 180°. The right recess 215R includes a right first end 216R and a right second end 217R in this order from the base side to the tip side. Each of the ends 216R, 217R includes an end surface tilted at a predetermined angle (at an angle of 45° in the present embodiment) with respect to the axis LB. Note that the predetermined angle of the right recess 215R is not limited to an angle of 45° and may be any angle less than an angle of 180°. As shown in FIG. 3A, the end surface of the left first end 216L and the end surface of the right second end 217R are parallel to each other, and the end surface of the left second end 217L and the end surface of the right first end 216R are parallel to each other. Hereinafter, a gap between the clamping claw 212L and the clamping claw 212R in the chucking direction, more specifically, a gap ΔCD between an end surface of the inner end 214L of the clamping claw 212L perpendicular to the chucking direction CD and an end surface of the inner end 214R of the clamping claw 212R perpendicular to the chucking direction CD is referred to as chuck width. As a pulse value in the servomotor 22 and the chuck width ΔCD are in proportion to each other, the chuck width ΔCD can be computed from a servo pulse value of the encoder included in the servomotor 22 with a given expression.

FIG. 3B illustrates a state in which the clamping claws 212L, 212R are at the closest approach to each other to minimize the chuck width in a state in which the engine damper 1 is disposed between the clamping claws 212L, 212R. As shown in FIG. 3B, the chuck width is minimized when the clamping claws 212L, 212R are at the closest approach to each other, and the outer surface of the engine damper 1 comes into contact with four points, i.e., the ends 216L, 217L of the clamping claw 212L and the ends 216R, 217R of the clamping claw 212R. Hereinafter, the chuck width minimized like this when the clamping claws 212L, 212R are at the closest approach to each other is referred to as a minimum chuck width. In this case, a holding center axis LH of the clamping claws 212L, 212R indicated by an open circle in FIG. 3B is coaxial with the damper axis D of the engine damper 1. In other words, the clamping claws 212L, 212R can hold the engine damper 1 at the center thereof when the clamping claws 212L, 212R are at the closest approach to each other. Here, the holding center axis LH is a line extending in the thickness direction of the clamping claws 212L, 212R and passing through the center point at which an axis LT, which is a line that passes through the center of the left recess 215L in the longitudinal direction LD and the center of the right recess 215R in the longitudinal direction LD, crosses the axis D.

Note that, hereinafter, the holding center axis LH, the axis LB, and the axis LT that characterize the postures of the clamping claws 212L, 212R are referred to as a H-axis LH, a B-axis LB, and a T-axis LT.

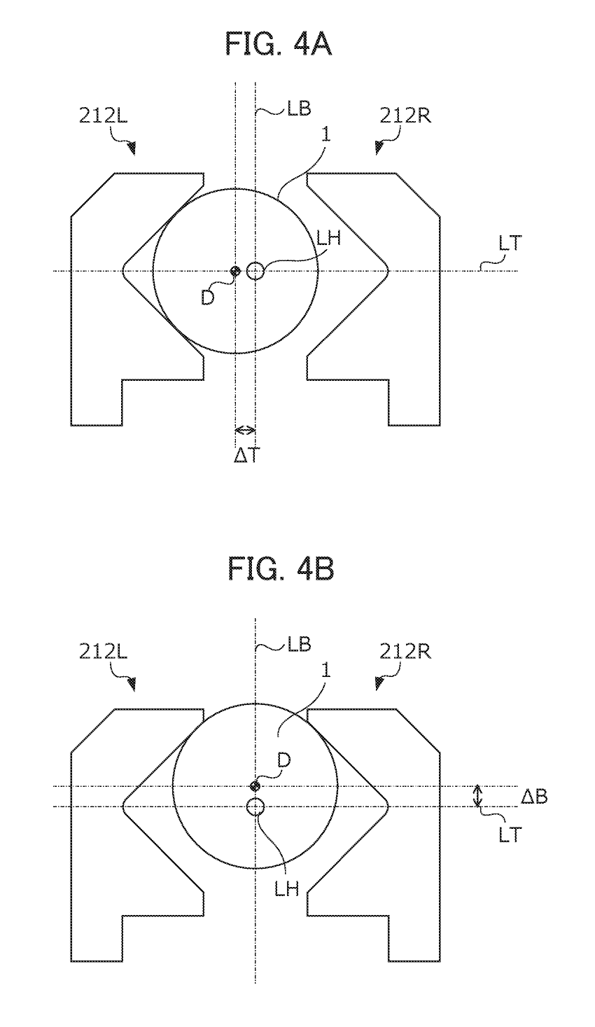

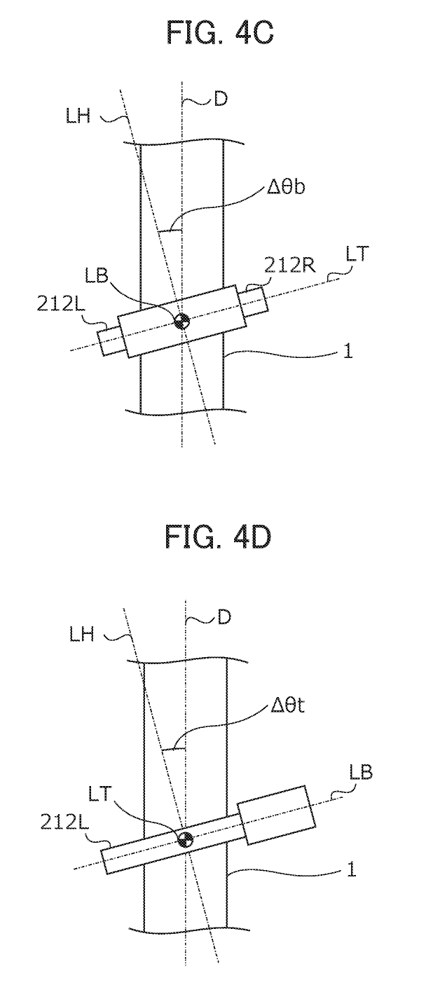

Deviations of the holding position of the engine damper 1 by the clamping claws 212L, 212R are described below with reference to FIG. 4A to FIG. 4D. Here, the description is directed to a state in which the chuck width is not minimized due to the deviations of the H-axis LH of the clamping claws 212L, 212R from the damper axis D. As shown in FIGS. 4A to 4D, the holding deviations by the clamping claws 212L, 212R includes four kinds of deviation mode, i.e., a T-axis translational deviation, a B-axis translational deviation, a B-axis tilting deviation, and a T-axis tilting deviation.

FIG. 4A schematically shows the T-axis translational deviation. As shown in FIG. 4A, the T-axis translational deviation refers to a state in which the H-axis LH is shifted from the damper axis D of the engine damper 1 along the T-axis LT by a predetermined distance. The T-axis translational deviation is characterized by a distance ΔT between the H-axis LH and the damper axis D along the T-axis LT.

FIG. 4B schematically shows the B-axis translational deviation. As shown in FIG. 4B, the B-axis translational deviation refers to a state in which the H-axis LH is shifted from the damper axis D of the engine damper 1 along the B-axis LB by a predetermined distance. The B-axis translational deviation is characterized by a distance ΔB between the H-axis LH and the damper axis D along the B-axis LB.

FIG. 4C schematically shows the B-axis tilting deviation. As shown in FIG. 4C, the B-axis tilting deviation refers to a state in which the H-axis LH is tilted from the damper axis D of the engine damper 1 by a predetermined angle as viewed along the B-axis LB. The B-axis tilting deviation is characterized by an angle Δθb formed between the H-axis LH and the damper axis D as viewed along the B-axis LB.

FIG. 4D schematically shows the T-axis tilting deviation. As shown in FIG. 4D, the T-axis tilting deviation refers to a state in which the H-axis LH is tilted from the damper axis D of the engine damper 1 by a predetermined angle as viewed along the T-axis LT. The T-axis tilting deviation is characterized by an angle Δθt formed between the H-axis LH and the damper axis D as viewed along the T-axis LT.

The actual holding deviations appear in combination of the above four modes of deviations. Accordingly, the actual holding deviations are identified by the four values, i.e., the two distances (ΔT, ΔB) and the two angles (Δθb, Δθt).

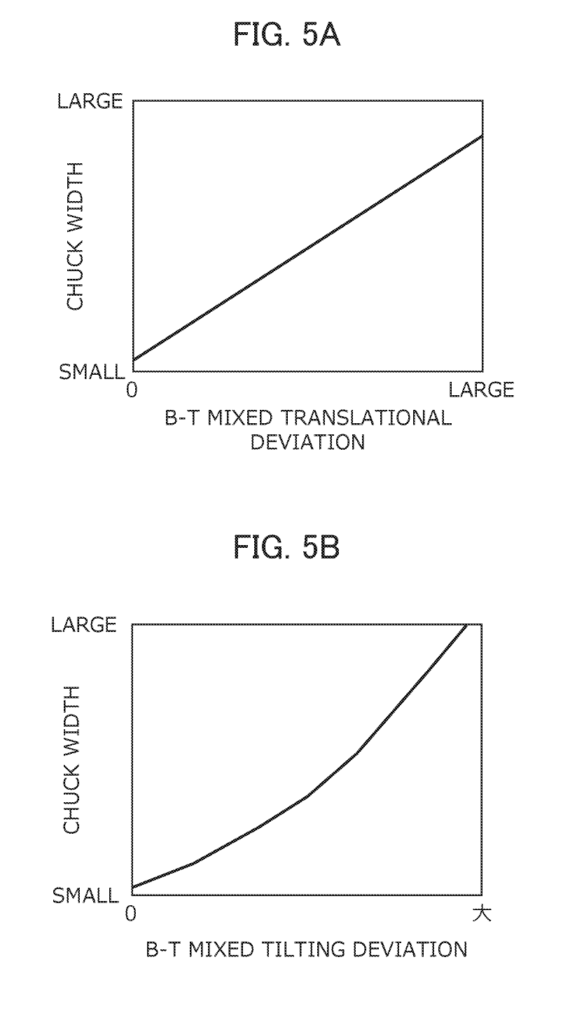

FIG. 5A shows a relationship between a magnitude of a B-T mixed translational deviation, which is defined by combining the B-axis translational deviation and the T-axis translational deviation by a predetermined proportion, and the chuck width. FIG. 5B shows a relationship between a magnitude of a B-T mixed tilting deviation, which is defined by combining the B-axis tilting deviation and the T-axis tilting deviation by a predetermined proportion, and the chuck width. The relationships between the mixed deviations and the chuck width shown in FIGS. 5A and 5B can be analytically derived by geometric computation.

Although the mode and the magnitude of a holding deviation that actually occurs cannot be identified solely from the chuck width, a condition of the holding deviation can be partly identified by the chuck width even when the deviation is a mixed deviation as shown in FIGS. 5A and 5B.

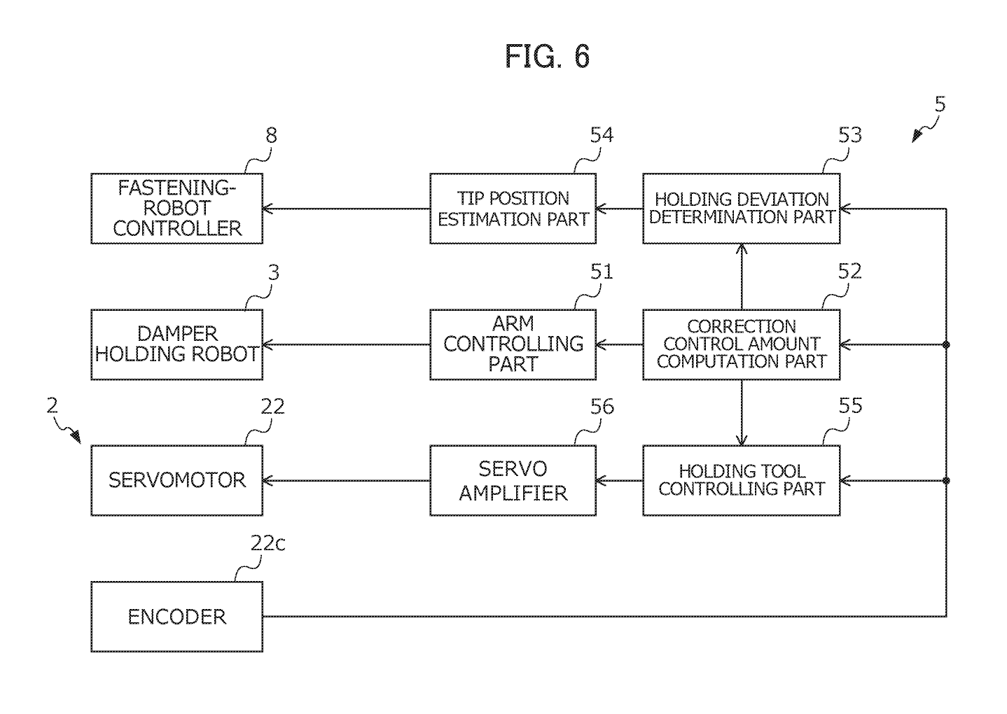

FIG. 6 is a block diagram schematically showing a configuration of a holding-robot controller 5. The holding-robot controller 5 includes an arm controlling part 51, a correction control amount computation part 52, a holding deviation determination part 53, an end position estimation part 54, a holding tool controlling part 55, and a servo amplifier 56, and is configured to control the damper holding robot 3 and the holding tool 2 with these components.

When the clamping claws 212L, 212R are to hold the engine damper 1 by approaching each other, or when the clamping claws 212L, 212R are to release the engine damper 1 by separating from each other, the holding tool controlling part 55 computes a torque command value corresponding to the condition at the moment and outputs the value to the servo amplifier 56. According to the torque command value transmitted from the holding tool controlling part 55, the servo amplifier 56 generates a pulse signal to carry out the command, and controls the servomotor 22 by inputting the pulse signal into the servomotor 22. The holding tool controlling part 55 sets the torque command value as a small value of about 20% of the maximum value thereof, so as to perform a temporary holding control in which the clamping claws 212L, 212R are brought into contact with the engine damper 1 while suppressing a significant change in the posture of the engine damper 1.

The arm controlling part 51 sets a target position and a target posture of the holding tool 2 provided on the tip end 31 of the arm of the damper holding robot 3, generates a control signal to reach the targets, and inputs the control signal to the damper holding robot 3 to control the position and the posture of the holding tool 2. In the case where the holding tool controlling part 55 performs the temporary holding control repeatedly as described below with reference to the flowchart shown in FIG. 7, the arm controlling part 51 revises the target position and the target posture of the holding tool 2 from the target position and the target posture that has been set at the time of the previous temporary holding control to a position and a posture that are corrected corresponding to a correction control amount computed by the correction control amount computation part 52.

The correction control amount computation part 52 computes the chuck width between the clamping claws 212L, 212R with the motor pulse signal from the encoder 22c. The correction control amount computation part 52 computes the correction control amount from the current position and the current posture of the holding tool 2 with the computed chuck width as an input so as to reduce the chuck width, in other words, each of the above described four parameters (ΔT, AB, Δθb, Δθt) representing the holding deviation shifts toward zero. The correction control amount computation part 52 having input-output characteristics from the chuck width to the correction control amount is constructed by a known reinforcement learning algorithm such as Q-learning or a Monte Carlo method, for example.

The holding deviation determination part 53 computes the chuck width between the clamping claws 212L, 212R with the motor pulse signal transmitted from the encoder 22c. The holding deviation determination part 53 determines whether the computed chuck width is equal to or less than a threshold value that has been set at a value slightly higher than the minimum chuck width to determine whether the holding deviation has mostly disappeared.

The end position estimation part 54 estimates position coordinates of the threaded hole 17 at the tip end 16 of the engine damper 1 using on a deviation from a known predetermined reference position and a known predetermined reference posture of the position and the posture of the holding tool at the time of the determination by the holding deviation determination part 53 that the holding deviation has mostly disappeared, and transmits information on the estimated position coordinates to the fastening-robot controller 8.

FIG. 7 is a flowchart illustrating specific steps of the position estimation method to estimate the position of the threaded hole 17 of the engine damper 1 using the engine-damper mounting system S as described above.

In S1, the holding-robot controller 5 drives the damper holding robot 3 and the holding tool 2 to put the engine damper 1 in a temporary fastening state in which the recess 15 at the base end 13 of the engine damper 1 is engaged with the projection M1 on the engine mount and the threaded hole 17 formed on the tip end 16 of the engine damper 1 is positioned on the damper mounting part E1 mounted on the engine, and then returns the tip end 31 of the arm to a predetermined origin position.

Then, in S2, the holding-robot controller 5 performs an initial temporary holding step. In this initial temporary holding step, the arm controlling part 51 sets the target position and the target posture of the holding tool 2 at a predetermined reference position and reference posture near the engine damper, and also controls the holding tool 2 toward the target position and the target posture. Then, the holding tool controlling part 55 and the servo amplifier 56 cause the clamping claws 212L, 212R to approach each other into the reference position and the reference posture to perform the temporary holding control to temporarily hold the engine damper 1 with the clamping claws 212L, 212R.

In S3, the holding-robot controller 5 performs a position/posture correction step. In this position/posture correction step, the correction control amount computation part 52 computes the chuck width from the motor pulse value at the time of the current temporary holding control, more specifically, when either of the two clamping claws 212L, 212R touches the engine damper 1. Further, the correction control amount computation part 52 computes a correction control amount relating to each of the position and the posture of the holding tool with the computed chuck width at the current temporary holding control as an input such that the chuck width at the time of the next temporary holding is smaller than the chuck width at the time of the current temporary holding. The correction control amount corresponds to the amount that compensates for a difference between the position and the posture of the holding tool at the time of the current temporary holding control and a position and a posture at the time of the next temporary holding control in which the chuck width is expected to be reduced.

Then, in this position/posture correction step, the holding tool controlling part 55 and the servo amplifier 56 causes the clamping claws 212L, 212R to be separated from each other. Next, the arm controlling part 51 revises the target position and the target posture of the holding tool 2 at the current temporary holding using the correction control amount computed by the correction control amount computation part 52, and controls the holding tool 2 toward the revised target position and the target posture.

In S4, the holding-robot controller 5 performs a temporary re-holding step. In this temporary re-holding step, the holding tool controlling part 55 and the servo amplifier 56 perform the temporary holding control again in the position and the posture that have been corrected in the position/posture correction step in S3.

In S5, the holding-robot controller 5 performs a holding deviation determination step. In this holding deviation determination step, the holding deviation determination part 53 computes the chuck width at the time of performing the temporary holding control from the motor pulse value at the time of performing the temporary holding in S4. The holding deviation determination part 53 determines whether the computed chuck width is equal to or less than a threshold value that has been set at a value slightly higher than the minimum chuck width. When the determination result in S5 is NO, the holding-robot controller 5 determines that the holding deviation is not sufficiently small, and returns to S3 to perform the position/posture correction step and the temporary re-holding step again. In the case where the determination result in S5 is YES, the holding-robot controller 5 determines that the holding deviation is sufficiently small, and proceeds to S6.

In S6, the holding-robot controller 5 performs a position estimation step. In this position estimation step, the end position estimation part 54 computes a deviation of a position and a posture of the holding tool 2 at the time of the last temporary holding control from the reference position and the reference posture that are a position and a posture of the holding tool 2 at the time of firstly performing a temporary holding control, and uses the deviation to estimate the position of the threaded hole 17 formed on the tip end 16 of the engine damper 1. As being engaged with the projection M1 formed on the engine mount, the position of the recess 15 formed at the base end 13 of the engine damper 1 is known. The length of the engine damper 1 is also known. Accordingly, the holding-robot controller 5 can estimate the position of the threaded hole 17 by using the known information and the information on the deviation as described above. The holding-robot controller 5 transmits the position information thus estimated to the fastening-robot controller 8.

### Second Embodiment

A second embodiment of the present invention is described below with reference to the drawings. The engine-damper mounting system SA according to the present embodiment differs from the engine-damper mounting system S according to the first embodiment mainly in the configuration of a holding tool 2A. In the following description, the components identical to those of the engine-damper mounting system S according to the first embodiment are denoted by the same reference numerals and detailed descriptions thereof are omitted.

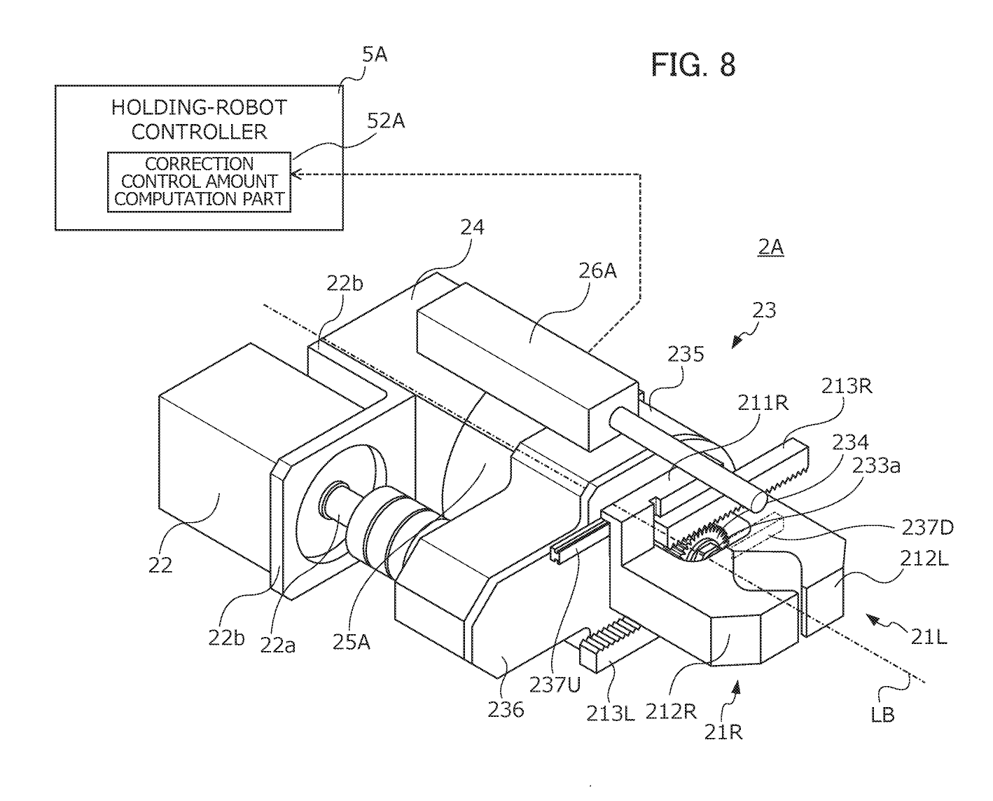

FIG. 8 is a perspective view of a configuration of the holding tool 2A. The holding tool 2A differs from the holding tool 2 in FIG. 2 in that the holding tool 2A further includes a force sensor 25A and a contact sensor 26A in addition to the clamping plates 21L, 21R, the servomotor 22, the power transmission mechanism 23, and the connection member 24.

The force sensor 25A is provided between the connection member 24 and the gear box 235 coaxially with the axis LB. The force sensor 25A detects six forces, i.e., three forces respectively along the three axes (Fx, Fy, Fz) and the three moments (Mx, My, Mz) respectively about the three axes, and transmits a signal corresponding to the detected values to the holding-robot controller 5A.

The contact sensor 26A is provided on the upper surface of the gear box 235 in such a manner that the rod 261A is parallel to the axis LB. The contact sensor 26A moves the rod 261A forward in the direction of the clamping plates 21L, 21R according to the command from the holding-robot controller 5A, and, transmits a signal indicating the presence of an object between the clamping plates 21L, 21R to the holding-robot controller 5A when the tip end of the rod 261A comes into contact with the object. The holding-robot controller 5A confirms in advance the presence of the engine damper by using the contact sensor 26A at the time of performing a control to hold the engine damper with the clamping plates 21L, 21R.

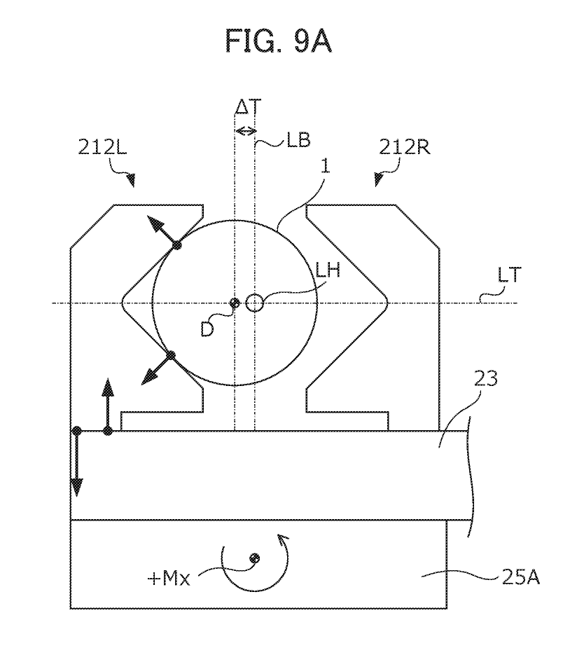

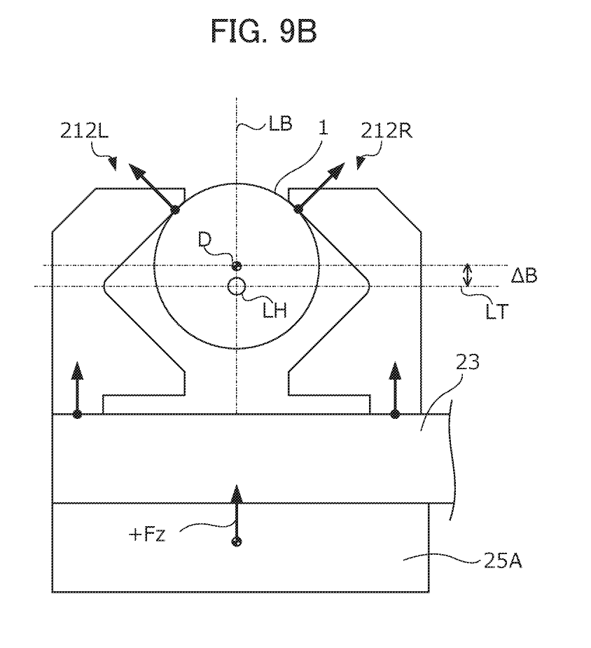

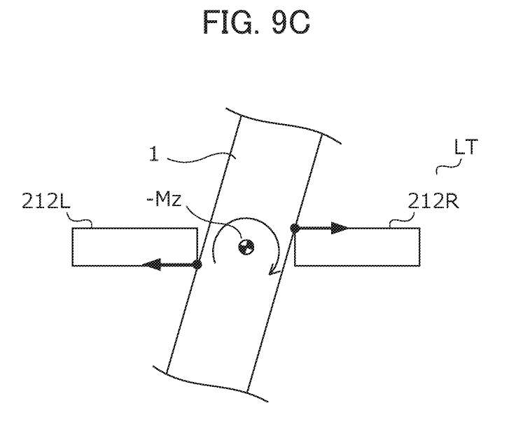

Here, a relationship between the output of the force sensor 25A and the holding deviation is described below. FIG. 9A schematically shows the T-axis translational deviation. As shown in FIG. 9A, in the case where the T-axis translational deviation occurs such that the engine damper 1 comes into contact with only a left clamping claw 212L of two clamping claws 212L, 212R, the force sensor 25A detects a positive moment Mx about the X-axis. In the case where the T-axis translational deviation in the opposite direction occurs such that the engine damper 1 comes into contact with only the right clamping claw 212R, the force sensor 25A detects a negative moment −Mx about the X-axis.

FIG. 9B schematically shows the B-axis translational deviation. As shown in FIG. 9B, in the case where the B-axis translational deviation occurs such that the engine damper 1 comes into contact with the two clamping claws 212L, 212R only at the left second end 217L and the right second end 217R, the force sensor 25A detects a positive force Fz along the Z-axis. In the case where the B-axis translational deviation in the opposite direction occurs such that the engine damper 1 comes into contact with the two clamping claws 212L, 212R only at the left first end 216L and the right first end 216R, the force sensor 25A detects a negative force −Fz along the Z-axis.

FIG. 9C schematically shows the B-axis tilting deviation. As shown in FIG. 9C, in the case where the B-axis tilting deviation occurs such that the engine damper 1 comes into contact with the left clamping claw 212L only at the lower surface thereof and comes into contact with the right clamping claw 212R only at the upper surface thereof, the force sensor 25A detects a negative moment −Mz about the Z-axis. In the case where the B-axis tilting deviation in the opposite direction occurs such that the engine damper 1 comes into contact with the left clamping claw 212L only at the upper surface thereof and comes into contact with the right clamping claw 212R only at the lower surface thereof, the force sensor 25A detects a positive moment Mz about the Z-axis.

As described above, the B-axis translational deviation, the T-axis translational deviation, the B-axis tilting deviation, and the T-axis tilting deviation can be separated from one another with the detection signals of the force sensor 25A, and the amount of deviation in each of the deviations can be identified independently. Accordingly, the correction control amount computation part 52A of the holding-robot controller 5A of the present embodiment computes the correction control amount from the current position and the current posture of the holding tool 2A with the detection signal of the force sensor 25A in addition to the motor pulse signal transmitted from the encoder (not shown) of the servomotor 22 as inputs so as to reduce the chuck width, in other words, so as to cause each of the four parameters (ΔT, ΔB, Δθb, Δθt) representing the holding deviations to shift toward zero. As described above, the correction control amount computation part 52A according to the present embodiment further utilizes the detection signal of the force sensor 25A and computes an appropriate correction control amount that causes an immediate reduction in the holding deviation.

### Third Embodiment

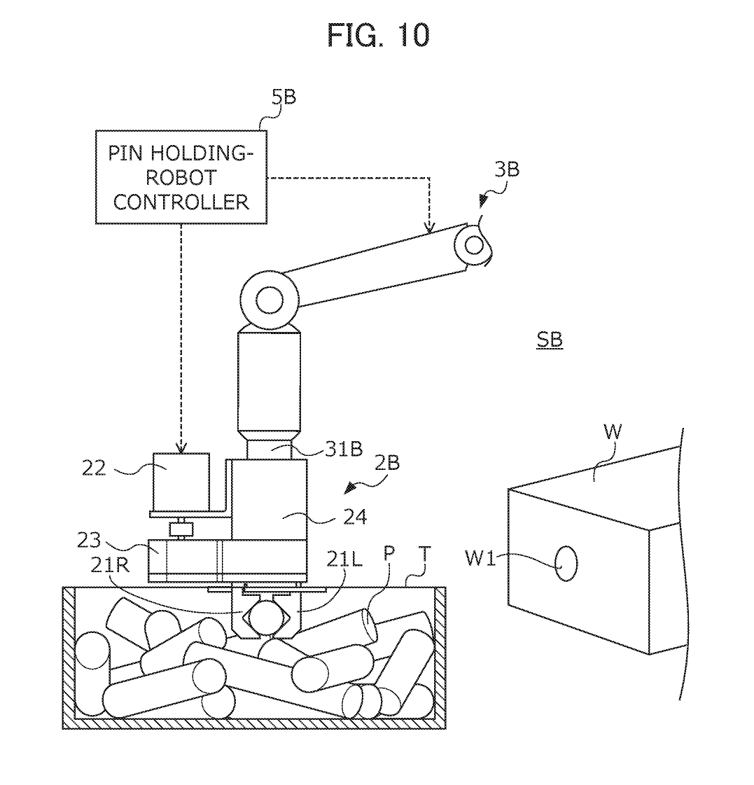

A third embodiment of the present invention is described below with reference to the drawings. FIG. 10 shows a configuration of a pin insertion system SB to which the holding method according to the present embodiment is applied. In the following description, the components identical to those of the engine-damper mounting system S according to the first embodiment are denoted by the same reference numerals and detailed descriptions thereof are omitted.

The pin insertion system SB extracts one of a plurality of pin members P stored in a box-shaped tray T and inserts the extracted pin member P into a hole W1 formed in a work W. The pin insertion system SB includes a holding tool 2B configured to hold a pin member P, a pin holding robot 3B of which arm is equipped with the holding tool 2B at a tip end 31B thereof, and a pin holding-robot controller 5B configured to control the holding tool 2B and the pin holding robot 3B.

Each of the pin members P has a cylindrical shape as a whole. The pin members P are randomly stored in the tray T without neatly arranging the positions and the postures thereof. The inside diameter of the hole W1 formed on the work W is slightly larger than the outside diameter of each of the pin members P. Thus, in order to insert the pin member P into the hole W1, it is required to grasp the position of the end of the pin member P and coaxially arrange the pin member P and the hole W1.

The configuration of the holding tool 2B is the same as that of the holding tool 2 described above with reference to FIG. 2. Specifically, the holding tool 2B includes a pair of clamping plates 21L, 21R, a servomotor 22, a power transmission mechanism 23, and a connection member 24, and is configured to hold or release the pin member P by causing the clamping plates 21L, 21R to approach or move away from each other using the power generated by the servomotor 22.

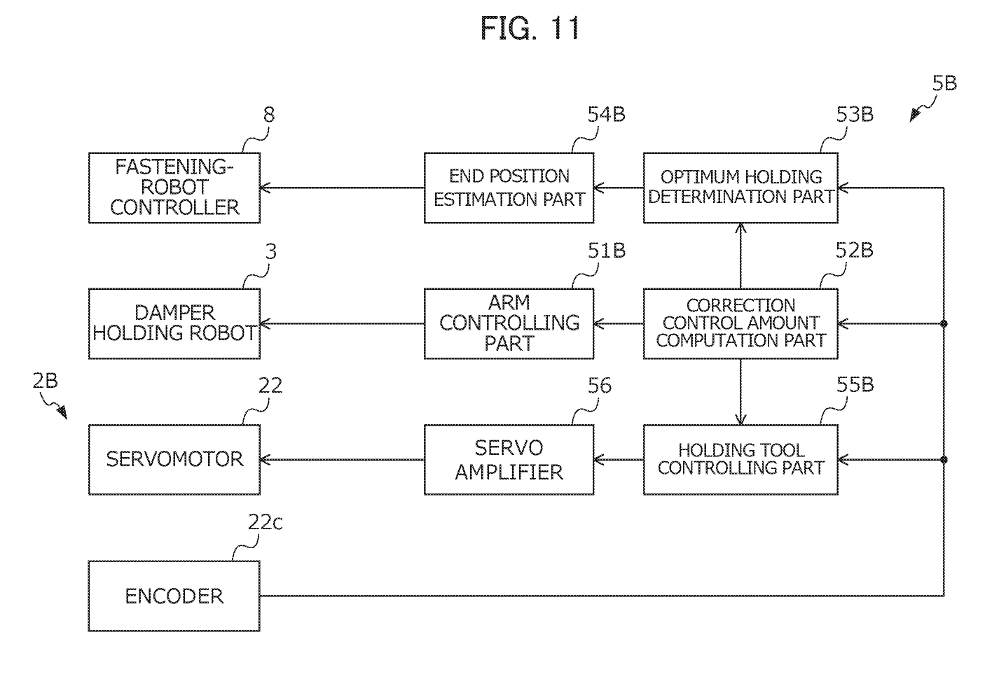

FIG. 11 is a block diagram schematically showing the configuration of a pin holding-robot controller 5B. The pin holding-robot controller 5B includes an arm controlling part 51B, a correction control amount computation part 52B, an optimum holding determination part 53B, an end position estimation part 54B, a holding tool controlling part 55B, and a servo amplifier 56, and is configured to control the pin holding robot 3B and the holding tool 2B with these components.

When the clamping claws 212L, 212R are to hold the pin member P by approaching each other, or when the clamping claws 212L, 212R are to release the pin member P by separating from each other, the holding tool controlling part 55B computes a torque command value corresponding to the condition at the moment and outputs the value to the servo amplifier 56.

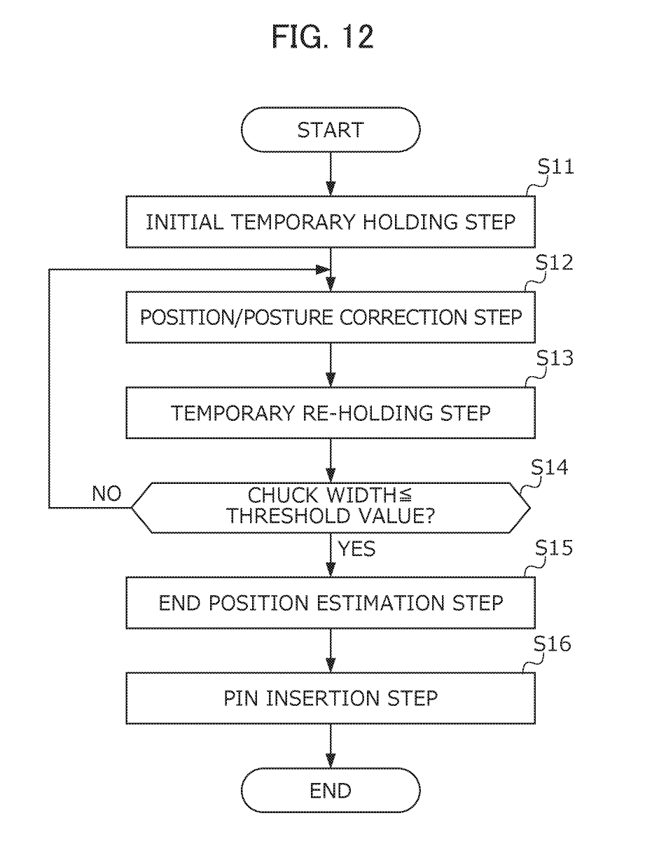

The arm controlling part 51B sets a target position and a target posture of the holding tool 2B provided on the tip end 31B of the arm of the pin holding robot 3B, generates a control signal to reach the targets, and controls the position and the posture of the holding tool 2B by inputting the control signal to the pin holding robot 3B. In the case where the holding tool controlling part 55B performs the temporary holding control repeatedly as described below with reference to the flowchart shown in FIG. 12, the arm controlling part 51B revises the target position and the target posture of the holding tool 2B from the target position and the target posture that has been set at the time of the previous temporary holding control to a position and a posture that are corrected corresponding to a correction control amount computed by the correction control amount computation part 52B.

The correction control amount computation part 52B computes the chuck width between the clamping claws 212L, 212R with the motor pulse signal from the encoder 22c. The correction control amount computation part 52B computes the correction control amount from the current position and the current posture of the holding tool 2B with the computed chuck width as an input so as to reduce the chuck width, in other words, each of the four parameters (ΔT, ΔB, Δθb, Δθt) representing the holding deviations of the pin member P shifts toward zero.

The optimum holding determination part 53B computes the chuck width between the clamping claws 212L, 212R with the motor pulse signal transmitted from the encoder 22c. The optimum holding determination part 53B determines whether the computed chuck width is equal to or less than a threshold value that has been set at a value slightly higher than the minimum chuck width to determine whether the pin member P is held at an optimum holding state by the clamping claws 212L, 212R. Here, the optimum holding state refers to a state in which the clamping claws 212L, 212R hold the pin member P at the center thereof as described above with reference to FIG. 3B. When the pin member P is held in the optimum holding state, the position of the end of the pin member P held by the clamping claws 212L, 212R can be estimated with the information that can be obtained without using a camera or a robot, such as the length of the pin member P and the holding position of the pin member P by the clamping claws 212L, 212R.

After the determination by the optimum holding determination part 53B that the pin member P is held in the optimum holding state, the end position estimation part 54B estimates the position coordinates of the end of the pin member P using the information on the length of the pin member P, the holding position of the pin member P, and the like.

FIG. 12 is a flowchart illustrating specific steps of a holding method to hold the pin member P using the above described pin insertion system SB and a step of inserting the pin member P held by using the holding method into the hole W1 of the work W.

Firstly, in S11, the pin holding-robot controller 5B performs an initial temporary holding step. In this initial temporary holding step, the arm controlling part 51B sets the target position and the target posture of the holding tool 2B to a reference position and a reference posture defined within the tray T, and controls the holding tool 2B toward the target position and the target posture. Then, the holding tool controlling part 55B and the servo amplifier 56 cause the clamping claws 212L, 212R to approach each other in the reference position and the reference posture, and perform a temporary holding control in which the pin member P stored in the tray T is temporarily held by the clamping claws 212L, 212R.

In S12, the pin holding-robot controller 5B performs a position/posture correction step. In this position/posture correction step, the correction control amount computation part 52B firstly computes the chuck width from the motor pulse value at the time of performing the current temporary holding control. Further, the correction control amount computation part 52B computes a correction control amount relating to each of the position and the posture of the holding tool with the computed chuck width at the current temporary holding control as an input such that the chuck width at the time of the next temporary holding control is smaller than the chuck width at the time of the current temporary holding control. The correction control amount corresponds to the amount that compensates for a difference between the position and the posture of the holding tool at the time of the current temporary holding control and a position and a posture at the time of the next temporary holding control in which the chuck width is expected to be reduced.

Then, in this position/posture correction step, the holding tool controlling part 55B and the servo amplifier 56 cause the clamping claws 212L, 212R to be separated from each other. Then, the arm controlling part 51B corrects the target position and the target posture of the holding tool 2 at the current temporary holding by using the correction control amount computed by the correction control amount computation part 52B, and controls the holding tool 2 toward the revised target position and target posture.

In S13, the pin holding-robot controller 5B performs a temporary re-holding step. In this temporary re-holding step, the holding tool controlling part 55B and the servo amplifier 56 perform the temporary holding control again in the position and the posture that have been corrected in the position/posture correction step in S12.

In S14, the pin holding-robot controller 5B performs a holding deviation determination step. In this holding deviation determination step, the optimum holding determination part 53B computes the chuck width at the time of performing the temporary holding control from the motor pulse value when performing the temporary holding in S13. The optimum holding determination part 53B determines whether the computed chuck width is equal to or less than a threshold value that has been set at a value slightly higher than the minimum chuck width. When the determination result in S14 is NO, the pin holding-robot controller 5B determines that the holding deviation is not sufficiently small, and returns to S12 to perform the position/posture correction step and the temporary re-holding step again. In the case where the determination result in S14 is YES, the pin holding-robot controller 5B determines that the holding deviation is sufficiently small and thus the pin member P is held at the optimum holding state by the holding tool 2B, and proceeds to S15.

In S15, the pin holding-robot controller 5B performs a position estimation step. In the position estimation step, the end position estimation part 54B estimates the position of the end of pin member P held in the optimum holding state. In S16, the pin holding-robot controller 5B inserts the pin member P into the hole W1 formed in a work W by using the information on the position of the end of the pin member P that has been estimated.

Although the embodiments of the present invention are described above, the present invention is not limited thereto.

What is claimed is:

1. A position estimation method that estimates end position coordinates of one end of a cylindrical object using a holding system configured to hold the cylindrical object,
the holding system including: a holding apparatus equipped with a pair of clamping claws configured to hold the cylindrical object such that a holding center axis is coaxial with a center axis of the cylindrical object when the clamping claws are in the closest approach to each other, and equipped with a holding width detection device configured to output a width detection value according to a holding width of the clamping claws; and a control device configured to control a position and a posture of the holding apparatus,
the control device including a correction device configured to output a correction control amount of the position and the posture of the holding apparatus so as to reduce the holding width when the width detection value is input,
the position estimation method comprising:
an initial temporary holding step of causing the pair of clamping claws to approach each other in a reference position and a reference posture and temporarily holding the cylindrical object;
a correction step of correcting the position and the posture of the holding apparatus with the correction control amount obtained by inputting the width detection value at a time of the temporary holding of the cylindrical object into the correction device;
a temporary re-holding step of causing the pair of clamping claws to approach each other in the position and the posture after the correction step and temporarily re-holding the cylindrical object; and
an estimation step of estimating the end position coordinates using a deviation from the reference position and the reference posture of the position and the posture of the holding apparatus when the width detection value is equal to or less than a threshold value after the correction step and the temporary re-holding step are repeated.

2. The position estimation method according to claim 1, wherein the correction device has input-output characteristics from the width detection value to the correction control amount constructed by reinforcement learning.

3. The position estimation method according to claim 1, wherein the control device includes: a robot having an arm of which tip end is equipped with the holding apparatus; and a robot controller configured to drive the robot to control the position and the posture of the holding apparatus,
wherein the holding apparatus includes: an actuator; a power transmission mechanism that causes the pair of clamping claws to approach or move away from each other using power generated by the actuator; and a force sensor with six axes provided between the power transmission mechanism and the tip end of the arm, and
wherein the correction device is configured to use the width detection value and a value detected by the force sensor and compute the correction control amount so as to reduce the holding width.

4. The position estimation method according to claim 2, wherein the control device includes: a robot having an arm of which tip end is equipped with the holding apparatus; and a robot controller configured to drive the robot to control the position and the posture of the holding apparatus,
wherein the holding apparatus includes: an actuator; a power transmission mechanism that causes the pair of clamping claws to approach or move away from each other using power generated by the actuator; and a force sensor with six axes provided between the power transmission mechanism and the tip end of the arm, and
wherein the correction device is configured to use the width detection value and a value detected by the force sensor and compute the correction control amount so as to reduce the holding width.

5. A holding method of holding a cylindrical object using a holding system,
the holding system including: a holding apparatus equipped with a pair of clamping claws configured to hold the cylindrical object such that a holding center axis is coaxial with a center axis of the cylindrical object when the clamping claws are in the closest approach to each other, and equipped with a holding width detection device configured to output a width detection value according to a holding width of the clamping claws; and a control device configured to control a position and a posture of the holding apparatus,
the control device including a correction device configured to output a correction control amount of the position and the posture of the holding apparatus so as to reduce the holding width when the width detection value is input,
the holding method comprising:
an initial temporary holding step of causing the pair of clamping claws to approach each other in a reference position and a reference posture and temporarily holding the cylindrical object;
a correction step of correcting the position and the posture of the holding apparatus with the correction control amount obtained by inputting the width detection value at a time of the temporary holding of the cylindrical object into the correction device; and
a temporary re-holding step of causing the pair of clamping claws to approach each other in the position and the posture after the correction step and temporarily re-holding the cylindrical object,
wherein the holding apparatus holds the cylindrical object by repeating the correction step and the temporary re-holding step until the width detection value is equal to or less than the threshold value.
